(19) United States
(12) Patent Application Publication
(10) Pub. No.: US 2026/0239288 A1
(43) Pub. Date: Aug. 13, 2026

(54) ADDING TRACKING AREA IDENTITIES OF CURRENT REGISTRATION AREA IN FORBIDDEN TRACKING AREA IDENTITY LIST AFTER NO SLICES AVAILABLE IN WIRELESS COMMUNICATIONS

(71) Applicant: MEDIATEK SINGAPORE PTE. LTD., Singapore (SG)

(72) Inventors: Puneet ., Bengaluru (IN); Marko NIEMI, Oulu (FI); Yuan-Chieh LIN, Hsinchu City (TW); Yu-Hsin LIN, Hsinchu City (TW)

(73) Assignee: MEDIATEK SINGAPORE PTE. LTD., Singapore (SG)

(21) Appl. No.: 19/475,130

(22) PCT Filed: Jul. 9, 2024
(86) PCT No.: PCT/CN2024/104374

§ 371 Date: Oct. 14, 2025

(30) Foreign Application Priority Data
Aug. 16, 2023 (IN) 202321054903
Oct. 3, 2023 (IN) 202321066174

(51) Int. Cl. H04W 64/00; H04W 48/18; H04W 60/00

(52) U.S. Cl. CPC H04W 64/00; H04W 48/18; H04W 60/00

(57) ABSTRACT

Techniques pertaining to adding tracking area identities (TAIs) of a current registration area in a forbidden tracking area identity (FTAI) list after no slices available in wireless communications are described. An apparatus (e.g., a user equipment (UE) ) receives, from a network, during a registration procedure a registration reject message with a rejection cause indicating no network slices available. In response to a condition being met, the apparatus stores one or more TAIs in a list of forbidden tracking areas for roaming. The condition at least includes: (1) the apparatus having an allowed network slice selection assistance information (NSSAI) or configured NSSAI; (2) all of one or more single NSSAIs (S-NSSAIs) in the allowed NSSAI or configured NSSAI being rejected; and (3) at least one of the one or more S-NSSAIs being rejected due to the respective S-NSSAI being not available in a current registration area.

### CROSS REFERENCE TO RELATED PATENT APPLICATION(S)

The present disclosure claims the priority benefit of Indian Patent Application Nos. 202321054903 and 202321066174, filed 16 Aug. 2023 and 3 Oct. 2023, respectively, the contents of which herein being incorporated by reference in their entirety.

### TECHNICAL FIELD

The present disclosure is generally related to mobile communications and, more particularly, to techniques of adding tracking area identities (TAIs) of a current registration area in a forbidden tracking area identity (FTAI) list after no slices available in wireless communications.

### BACKGROUND

In wireless communications such as mobile communications under the current 3rd Generation Partnership Project (3GPP) specification, when an initial registration procedure or mobility registration procedure or network-initiated de-registration procedure is rejected with a 5th Generation Mobility Management (5GMM) cause #62 (“No network slides available”), a user equipment (UE) receiving the rejected network slice selection assistance information (NSSAI) in the REGISTRATION REJECT message takes corresponding actions based on the rejection cause in the rejected single-network slice selection assistance information (S-NSSAI). The rejection cause may be, for example, “S-NSSAI not available in the current PLMN or SNPN”, “S-NSSAI not available in the current registration area”, “S-NSSAI not available due to the failed or revoked network slide-specific authentication and authorization”, or “S-NSSAI not available due to maximum number of UEs reached.”

When the registration is rejected with cause #62 and all the S-NSSAI(s) in the allowed NSSAI and configured NSSAI or in the default configured NSSAI are rejected, and at least one S-NSSAI is rejected due to “S-NSSAI not available in the current registration area,” the UE is to store the current TAI in a list of “5GS forbidden tracking areas for roaming” and memorize that the current TAI has been stored in the list of “5GS forbidden tracking areas for roaming” for the S-NSSAI that is rejected due to “S-NSSAI not available in the current registration area.” However, the UE is only adding the current TAI in a forbidden TAI (FTAI) list. As per the S-NSSAI is rejected due to “S-NSSAI not available in the current registration area,” the UE should not attempt to register with the current registration area since the UE is not to attempt to use this S-NSSAI in the current registration.

For example, given first, second and third TAIs (e.g., TAI1, TAI2 and TAI3), a UE is registered over TAIL and the registration area (RA) contains TAI1 and TAI2. In this example, the UE may have performed a mobility registration update (MRU) procedure and rejected with cause #62 and an NSSAI cause of “S-NSSAI is rejected due to ‘S-NSSAI not available in the current registration area.’” However, the UE would select TAI2 and the registration would be rejected again since the S-NSSAI should not be rejected in TAI2 as TAI2 is part of the current registration area. Therefore, there is a need for a solution of adding TAIs of a current registration area in a FTAI list after no slices available in wireless communications.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions pertaining to adding TAIs of a current registration area in a FTAI list after no slices available in wireless communications. It is believed that implementations of one or more of the schemes proposed herein may address or otherwise alleviate the issues described above.

In one aspect, a method may involve a UE receiving from a network during a registration procedure a registration reject message with a rejection cause indicating no network slices available. The method may also involve the UE storing one or more TAIs in a list of forbidden tracking areas for roaming responsive to a condition being met. The condition may at least include: (1) the UE having an allowed NSSAI or configured NSSAI; (2) all of one or more S-NSSAIs in the allowed NSSAI or configured NSSAI being rejected; and (3) at least one of the one or more S-NSSAIs being rejected due to the respective S-NSSAI being not available in a current registration area.

In another aspect, a method may involve a UE receiving from a network during a registration procedure a registration reject message with a rejection cause indicating no network slices available. The method may also involve the UE storing one or more TAIs in a list of forbidden tracking areas for roaming responsive to a condition being met. The condition may at least include: (1) the UE having neither allowed NSSAI for a current public land mobile network (PLMN) nor configured NSSAI for the current PLMN; (2) all of one or more S-NSSAIs in a default configured NSSAI being rejected; and (3) at least one of the one or more S-NSSAIs being rejected due to the respective S-NSSAI being not available in a current registration area.

In yet another aspect, a method may involve a UE receiving, from a network during a network-initiated deregistration procedure a deregistration request message with a rejection cause indicating no network slices available. The method may also involve the UE storing one or more TAIs in a list of forbidden tracking areas for roaming responsive to a condition being met. The condition may at least include: (1) the UE having neither allowed NSSAI for a current PLMN or standalone non-public network (SNPN) nor configured NSSAI for the current PLMN or SNPN; (2) all of one or more S-NSSAIs in a default configured NSSAI being rejected; and (3) at least one of the one or more S-NSSAIs being rejected due to the respective S-NSSAI being not available in a current registration area.

It is noteworthy that, although the description provided herein may be in the context of certain radio access technologies, networks, and network topologies such as 5th Generation (5G)/New Radio (NR)/Beyond Fifth-Generation (B5G) mobile communications, the proposed concepts, schemes and any variation(s)/derivative(s) thereof may be implemented in, for and by other types of radio access technologies, networks and network topologies such as, for example and without limitation, 4^{th} Generation (4G)/Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various solutions and schemes in accordance with the present disclosure may be implemented.

FIG. 2 is a block diagram of an example communication system in accordance with an implementation of the present disclosure.

FIG. 3 is a flowchart of a second example process in accordance with an implementation of the present disclosure.

FIG. 4 is a flowchart of a second example process in accordance with an implementation of the present disclosure.

FIG. 5 is a flowchart of a second example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to adding TAIs of a current registration area in a FTAI list after no slices available in wireless communications. According to the present disclosure, a number of possible solutions may be implemented separately or jointly. That is, although these possible solutions may be described below separately, two or more of these possible solutions may be implemented in one combination or another.

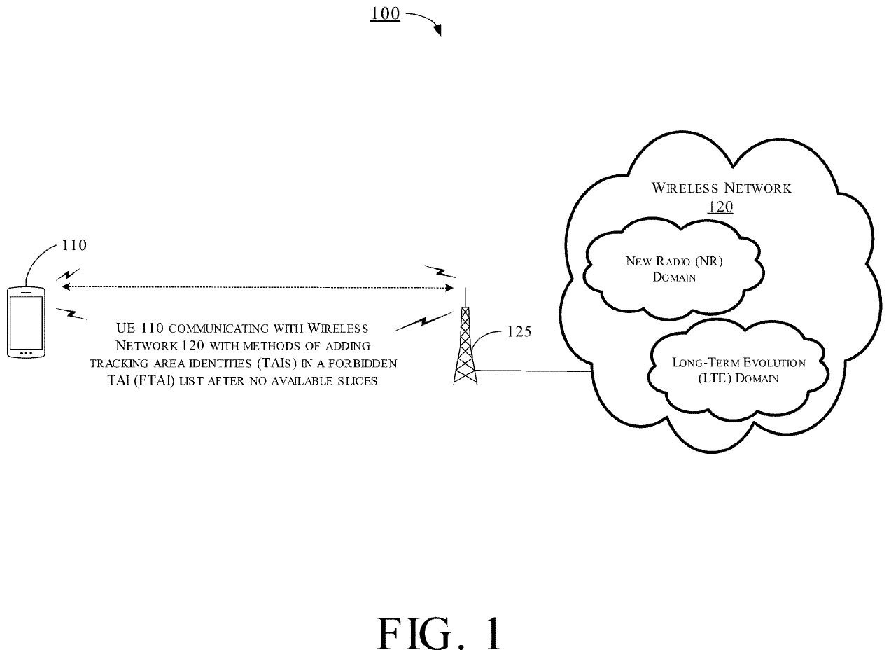

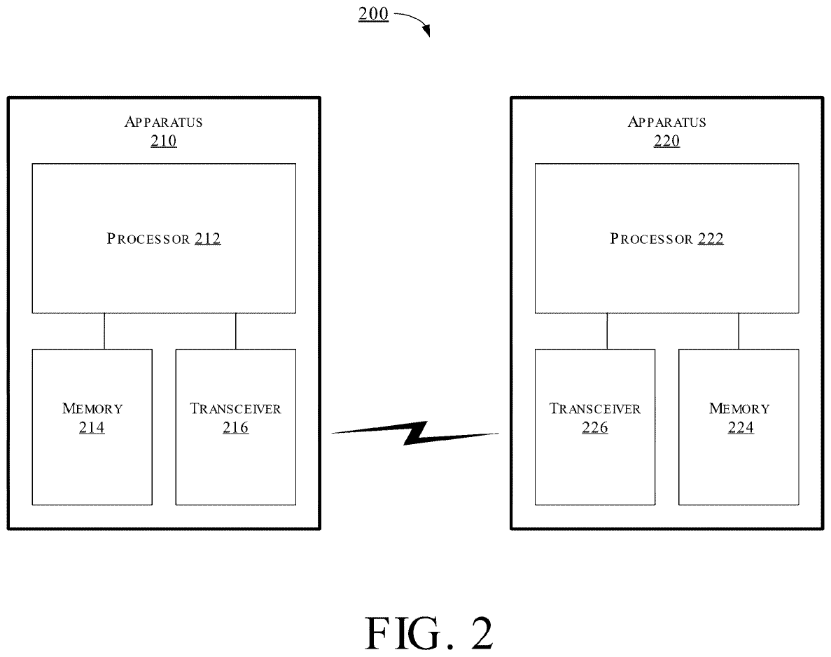

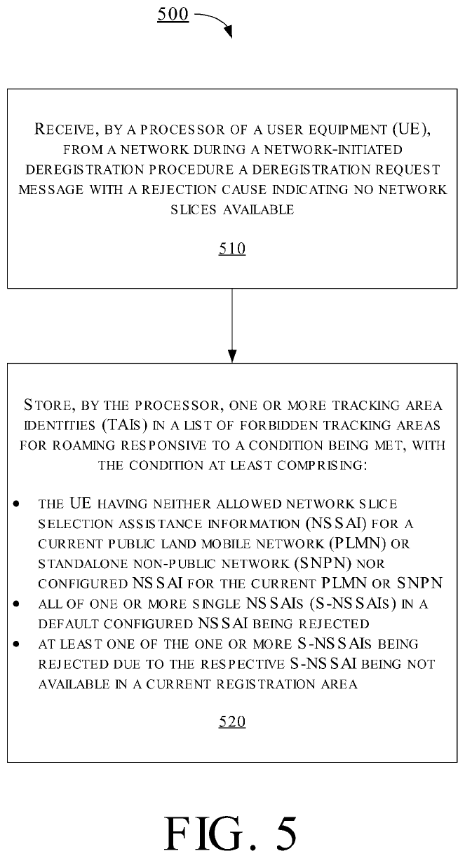

FIG. 1 illustrates an example network environment 100 in which various solutions and schemes in accordance with the present disclosure may be implemented. FIG. 2~FIG. 5 illustrate examples of implementation of various proposed schemes in network environment 100 in accordance with the present disclosure. The following description of various proposed schemes is provided with reference to FIG. 1~FIG. 5.

Referring to FIG. 1, network environment 100 may involve a UE 110, such as a mobile device or smartphone, in wireless communication with a wireless network 120 as part of a communication network. The wireless network 120 may be a public land mobile network (PLMN) including 5G/NR domain and 4G/LTE domain. UE 110 may initially be in wireless communication with wireless network 120 via a base station or network node 125 (e.g., an eNB, gNB or transmit-receive point (TRP)). In network environment 100, UE 110 and the wireless network 120 may implement various schemes pertaining to adding TAIs of a current registration area in a FTAI list after no slices available in wireless communications in accordance with the present disclosure, as described herein.

It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately. Moreover, as used herein, a lower layer may refer to a layer in the 5GMM protocol stack that is lower than the radio resource control (RRC) layer, such as a packet data convergence protocol (PDCP) layer, a radio control link (RLC) layer, a medium access control (MAC) layer, a physical (PHY) layer, or so forth.

Under a first proposed scheme in accordance with the present disclosure, in an event that a message with cause value #62 is received by UE 110 and in case that UE 110 has: (1) an allowed NSSAI or configured NSSAI and all the S-NSSAI(s) in the allowed NSSAI and configured NSSAI are rejected; and/or (2) neither allowed NSSAI for the current PLMN nor configured NSSAI for the current public land mobile network (PLMN) and all the S-NSSAI(s) in the default configured NSSAI are rejected, while at least one S-NSSAI is rejected due to “S-NSSAI not available in the current registration area”, then UE 110 may perform certain operations under the proposed scheme. For instance, UE 110 may add all TAIs belonging to current registration area in the list of “5GS forbidden tracking areas for roaming”, memorize that all the TAIs belonging to the current registration have been stored in the list of “5GS forbidden tracking areas for roaming” for S-NSSAI that is rejected due to “S-NSSAI not available in the current registration area.” Alternatively, or additionally, UE 110 may search for a suitable cell in another tracking area not belonging to current registration area according to 3GPP Technical Specification (TS) 38.304 or 3GPP TS 36.304.

Under a second proposed scheme in accordance with the present disclosure, in an event that a message with cause value #62 is received by UE 110 and in case that: (a) UE 110 has an allowed NSSAI or configured NSSAI and all the S-NSSAI(s) in the allowed NSSAI and configured NSSAI are rejected; and/or (b) UE 110 has neither allowed NSSAI for the current PLMN nor configured NSSAI for the current PLMN and all the S-NSSAI(s) in the default configured NSSAI are rejected; and/or (c) the registration procedure was not initiated when UE 110 detects that the current TAI is not in the list of tracking areas that UE 110 previously registered in the Access & Mobility Management Function (AMF); and/or (d) a network initiated de-registration procedure was initiated by network 130 or the AMF; and/or (e) at least one S-NSSAI is rejected due to “S-NSSAI not available in the current registration area”, then UE 110 may perform certain operations under the proposed scheme. For instance, UE 110 may add all TAIs belonging to current registration area in the list of “5GS forbidden tracking areas for roaming”, memorize that all TAIs belonging to current registration have been stored in the list of “5GS forbidden tracking areas for roaming” for the S-NSSAI that is rejected due to “S-NSSAI not available in the current registration area.” Alternatively, or additionally, UE 110 may search for a suitable cell in another tracking area not belonging to current registration area according to 3GPP TS 38.304 or 3GPP TS 36.304.

Under the second proposed scheme, in an event that a message with cause value #62 is received by UE 110 and in case that: (a) UE 110 has an allowed NSSAI or configured NSSAI and all the S-NSSAI(s) in the allowed NSSAI and configured NSSAI are rejected; and/or (b) UE 110 has neither allowed NSSAI for the current PLMN nor configured NSSAI for the current PLMN and all the S-NSSAI(s) in the default configured NSSAI are rejected; and/or (c) the registration procedure was initiated when UE 110 detects that the current TAI is not in the list of tracking areas that UE 110 previously registered in the AMF; and/or (d) at least one S-NSSAI is rejected due to “S-NSSAI not available in the current registration area”, then UE 110 may perform certain operations under the proposed scheme. For instance, UE 110 may add the current TAI only in the list of “5GS forbidden tracking areas for roaming”, memorize the current TAI was stored in the list of “5GS forbidden tracking areas for roaming” for the S-NSSAI that is rejected due to “S-NSSAI not available in the current registration area.” Alternatively, or additionally, UE 110 may search for a suitable cell in another tracking area according to 3GPP TS 38.304 or 3GPP TS 36.304.

In view of the above, several implementation examples are provided to illustrate and highlight benefits of the proposed schemes.

In a first example, in an event that UE 110 has an allowed NSSAI or configured NSSAI and at least one S-NSSAI of the allowed NSSAI or configured NSSAI is not included in the rejected NSSAI, UE 110 may stay in the current serving cell, apply the normal cell reselection process and start an initial registration with a requested NSSAI that includes any S-NSSAI from the allowed NSSAI or the configured NSSAI that is not in the rejected NSSAI.

In a second example, in an event that UE 110 has an allowed NSSAI or configured NSSAI and all the S-NSSAI(s) in the allowed NSSAI and configured NSSAI are rejected while at least one S-NSSAI is rejected due to “S-NSSAI not available in the current registration area”, and the REGISTRATION REJECT message is integrity protected, UE 110 may not be operating in a standalone non-public network (SNPN) access operation mode and the forbidden TAI(s) for the list of “5GS forbidden tracking areas for roaming” information element (IE) is not included in the REGISTRATION REJECT message, then UE 110 nay store all TAIs belonging to current registration area in the list of “5GS forbidden tracking areas for roaming”, memorize that all the TAIs belonging to current registration area have been stored in the list of “5GS forbidden tracking areas for roaming” for the S-NSSAI that is rejected due to “S-NSSAI not available in the current registration area” and enter the state 5GMM-DEREGISTERED. LIMITED-SERVICE.

Alternatively, in an event that UE 110 has an allowed NSSAI or configured NSSAI and all the S-NSSAI(s) in the allowed NSSAI and configured NSSAI are rejected while at least one S-NSSAI is rejected due to “S-NSSAI not available in the current registration area”, and the REGISTRATION REJECT message is integrity protected and the UE is operating in SNPN access operation mode, then the UE shall store all TAIs belonging to current registration area in the list of “5GS forbidden tracking areas for roaming”, memorize that all the TAIs belonging to current registration area have been stored in the list of “5GS forbidden tracking areas for roaming” for the S-NSSAI that is rejected due to “S-NSSAI not available in the current registration area” for the current SNPN and, in case that UE 110 supports access to an SNPN using credentials from a credentials holder, equivalent SNPNs or both, the selected entry of the “list of subscriber data” or the selected PLMN subscription, UE 110 may enter the state 5GMM-DEREGISTERED. LIMITED-SERVICE. In this example, UE 110 may search for a suitable cell in another tracking area not belonging to the current registration area according to 3GPP TS 38.304 or 3GPP TS 36.304.

In a third example, in an event that UE 110 has an allowed NSSAI or configured NSSAI and all the S-NSSAI(s) in the allowed NSSAI and configured NSSAI are rejected while at least one S-NSSAI is rejected due to “S-NSSAI not available in the current registration area”, and the REGISTRATION REJECT message is integrity protected, given that UE 110 is not operating in SNPN access operation mode and the Forbidden TAI(s) for the list of “5GS forbidden tracking areas for roaming” IE is not included in the REGISTRATION REJECT message and the REGISTRATION REJECT message is received from one of the TAI(s) in the current registration area, UE 110 may store the TAI(s) belonging to the registration area in the list of “5GS forbidden tracking areas for roaming”. On the other hand, in an event that the REGISTRATION REJECT message is received from a TAI not in the current registration area, UE 110 may store the current TAI in the list of “5GS forbidden tracking areas for roaming”. Moreover, UE 110 may enter the state 5GMM-REGISTERED. LIMITED-SERVICE. The UE shall search for a suitable cell in another tracking area according to 3GPP TS 38.304 or 3GPP TS 36.304. Alternatively, in an event that the REGISTRATION REJECT message is integrity protected and the UE is operating in SNPN access operation mode and the REGISTRATION REJECT message is received from one of the TAI(s) in the current registration area, UE 110 may store the TAI(s) belonging to current registration area in the list of “5GS forbidden tracking areas for roaming” for the current SNPN. Alternatively, in an event that the REGISTRATION REJECT message is received from a TAI not in the current registration area, UE 110 may store the current TAI in the list of “5GS forbidden tracking areas for roaming”. In an event that UE 110 supports access to an SNPN using credentials from a credentials holder, equivalent SNPNs or both, the selected entry of the “list of subscriber data” or the selected PLMN subscription and enter the state 5GMM-REGISTERED. LIMITED-SERVICE. Furthermore, UE 110 may search for a suitable cell in another tracking area according to 3GPP TS 38.304 or 3GPP TS 36.304.

In a fourth example, in an event that UE 110 has neither allowed NSSAI for the current PLMN or SNPN nor configured NSSAI for the current PLMN or SNPN and in case that all the S-NSSAI(s) in the default configured NSSAI are rejected and at least one S-NSSAI is rejected due to “S-NSSAI not available in the current registration area”, when the REGISTRATION REJECT message is integrity protected and UE 110 is not operating in SNPN access operation mode while the REGISTRATION REJECT message is received from one of the TAI(s) in the current registration area, UE 110 may store the TAI(s) belonging to current registration area in the list of “5GS forbidden tracking areas for roaming.” On the other hand, in an event that the REGISTRATION REJECT message is received from a TAI not in the current registration area, UE 110 may store the current TAI in the list of “5GS forbidden tracking areas for roaming”. Additionally, UE 110 may memorize that the TAI(s) was stored in the list of “5GS forbidden tracking areas for roaming” for S-NSSAI is rejected due to “S-NSSAI not available in the current registration area” and enter the state 5GMM-REGISTERED. LIMITED-SERVICE. Moreover, UE 110 may search for a suitable cell in another tracking area according to 3GPP TS 38.304 or 3GPP TS 36.304. Alternatively, in an event that the REGISTRATION REJECT message is integrity protected and UE 110 is operating in SNPN access operation mode and the REGISTRATION REJECT message is received from one of the TAI(s) in the current registration area, UE 110 may store the TAI(s) belonging to current registration area in the list of “5GS forbidden tracking areas for roaming.” On the other hand, in an event that the REGISTRATION REJECT message is received from a TAI not in the current registration area, UE 110 may store the current TAI in the list of “5GS forbidden tracking areas for roaming”. Moreover, UE 110 may memorize that the TAI(s) was stored in the list of “5GS forbidden tracking areas for roaming” for S-NSSAI is rejected due to “S-NSSAI not available in the current registration area” for the current SNPN and, in case that UE 110 supports access to an SNPN using credentials from a credentials holder, equivalent SNPNs or both, the selected entry of the “list of subscriber data” or the selected PLMN subscription and enter the state 5GMM-REGISTERED. LIMITED-SERVICE. Furthermore, UE 110 may search for a suitable cell in another tracking area according to 3GPP TS 38.304 or 3GPP TS 36.304.

In a fifth example, in an event that UE 110 has neither allowed NSSAI for the current PLMN or SNPN nor configured NSSAI for the current PLMN or SNPN and in case that all the S-NSSAI(s) in the default configured NSSAI are rejected and at least one S-NSSAI is rejected due to “S-NSSAI not available in the current registration area”, when the UE is not operating in SNPN access operation mode and the Forbidden TAI(s) for the list of “5GS forbidden tracking areas for roaming” IE is not included in the DEREGISTRATION REQUEST message, UE 110 may store the TAI(s) belonging to current registration area in the list of “5GS forbidden tracking areas for roaming”, and UE 110 may also memorize that the TAI(s) belonging to current registration area were stored in the list of “5GS forbidden tracking areas for roaming” for S-NSSAI is rejected due to “S-NSSAI not available in the current registration area” and enter the state 5GMM-DEREGISTERED. LIMITED-SERVICE. Moreover, UE 110 may search for a suitable cell in another tracking area not belonging to current registration area according to 3GPP TS 38.304 or 3GPP TS 36.304. Alternatively, in an event that UE 110 is operating in SNPN access operation mode, UE 110 may store the TAI(s) belonging to current registration area in the list of “5GS forbidden tracking areas for roaming”, and UE 110 may also memorize that the TAI(s) belonging to current registration area were stored in the list of “5GS forbidden tracking areas for roaming” for S-NSSAI is rejected due to “S-NSSAI not available in the current registration area” for the current SNPN and, in case that UE 110 supports access to an SNPN using credentials from a credentials holder, equivalent SNPNs or both, the selected entry of the “list of subscriber data” or the selected PLMN subscription and enter the state 5GMM-DEREGISTERED. LIMITED-SERVICE. Furthermore, UE 110 may search for a suitable cell in another tracking area not belonging to current registration area according to 3GPP TS 38.304 or 3GPP TS 36.304.

### Illustrative Implementations

FIG. 2 illustrates an example communication system 200 having at least an example apparatus 210 and an example apparatus 220 in accordance with an implementation of the present disclosure. Each of apparatus 210 and apparatus 220 may perform various functions to implement schemes, techniques, processes and methods described herein pertaining to adding TAIs of a current registration area in a FTAI list after no slices available in wireless communications, including the various schemes described above with respect to various proposed designs, concepts, schemes, systems and methods described above, including network environment 100, as well as processes described below.

Each of apparatus 210 and apparatus 220 may be a part of an electronic apparatus, which may be a network apparatus or a UE (e.g., UE 110), such as a portable or mobile apparatus, a wearable apparatus, a vehicular device or a vehicle, a wireless communication apparatus or a computing apparatus. For instance, each of apparatus 210 and apparatus 220 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 210 and apparatus 220 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 210 and apparatus 220 may be implemented in a smart thermostat, a smart fridge, a smart door lock, a wireless speaker or a home control center. When implemented in or as a network apparatus, apparatus 210 and/or apparatus 220 may be implemented in an eNodeB in an LTE, LTE-Advanced or LTE-Advanced Pro network or in a gNB or TRP in a 5G network, an NR network, or an IoT network.

In some implementations, each of apparatus 210 and apparatus 220 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 210 and apparatus 220 may be implemented in or as a network apparatus or a UE. Each of apparatus 210 and apparatus 220 may include at least some of those components shown in FIG. 2 such as a processor 212 and a processor 222, respectively, for example. Each of apparatus 210 and apparatus 220 may further include one or more other components not pertinent to the proposed scheme of the present disclosure (e.g., internal power supply, display device and/or user interface device), and, thus, such component(s) of apparatus 210 and apparatus 220 are neither shown in FIG. 2 nor described below in the interest of simplicity and brevity.

In one aspect, each of processor 212 and processor 222 may be implemented in the form of one or more single-core processors, one or more multi-core processors, or one or more CISC or RISC processors. That is, even though a singular term “a processor” is used herein to refer to processor 212 and processor 222, each of processor 212 and processor 222 may include multiple processors in some implementations and a single processor in other implementations in accordance with the present disclosure. In another aspect, each of processor 212 and processor 222 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 212 and processor 222 is a special-purpose machine specifically designed, arranged, and configured to perform specific tasks including those pertaining to adding TAIs of a current registration area in a FTAI list after no slices available in wireless communications in accordance with various implementations of the present disclosure.

In some implementations, apparatus 210 may also include a transceiver 216 coupled to processor 212. Transceiver 216 may be capable of wirelessly transmitting and receiving data. In some implementations, transceiver 216 may be capable of wirelessly communicating with different types of wireless networks of different radio access technologies (RATs). In some implementations, transceiver 216 may be equipped with a plurality of antenna ports (not shown) such as, for example, four antenna ports. That is, transceiver 216 may be equipped with multiple transmit antennas and multiple receive antennas for multiple-input multiple-output (MIMO) wireless communications. In some implementations, apparatus 220 may also include a transceiver 226 coupled to processor 222. Transceiver 226 may include a transceiver capable of wirelessly transmitting and receiving data. In some implementations, transceiver 226 may be capable of wirelessly communicating with different types of UEs/wireless networks of different RATs. In some implementations, transceiver 226 may be equipped with a plurality of antenna ports (not shown) such as, for example, four antenna ports. That is, transceiver 226 may be equipped with multiple transmit antennas and multiple receive antennas for MIMO wireless communications.

In some implementations, apparatus 210 may further include a memory 214 coupled to processor 212 and capable of being accessed by processor 212 and storing data therein. In some implementations, apparatus 220 may further include a memory 224 coupled to processor 222 and capable of being accessed by processor 222 and storing data therein. Each of memory 214 and memory 224 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 214 and memory 224 may include a type of read-only memory (ROM) such as mask ROM, programmable ROM (PROM), erasable programmable ROM (EPROM) and/or electrically erasable programmable ROM (EEPROM). Alternatively, or additionally, each of memory 214 and memory 224 may include a type of non-volatile random-access memory (NVRAM) such as flash memory, solid-state memory, ferroelectric RAM (FeRAM), magnetoresistive RAM (MRAM) and/or phase-change memory.

Each of apparatus 210 and apparatus 220 may be a communication entity capable of communicating with each other using various proposed schemes in accordance with the present disclosure. For illustrative purposes and without limitation, a description of capabilities of apparatus 210, as a UE (e.g., UE 110), and apparatus 220, as a network node (e.g., network node 125) of a network (e.g., wireless network 120 as a 5G/NR mobile network), is provided below in the context of example processes 300, 400 and 500.

### Illustrative Processes

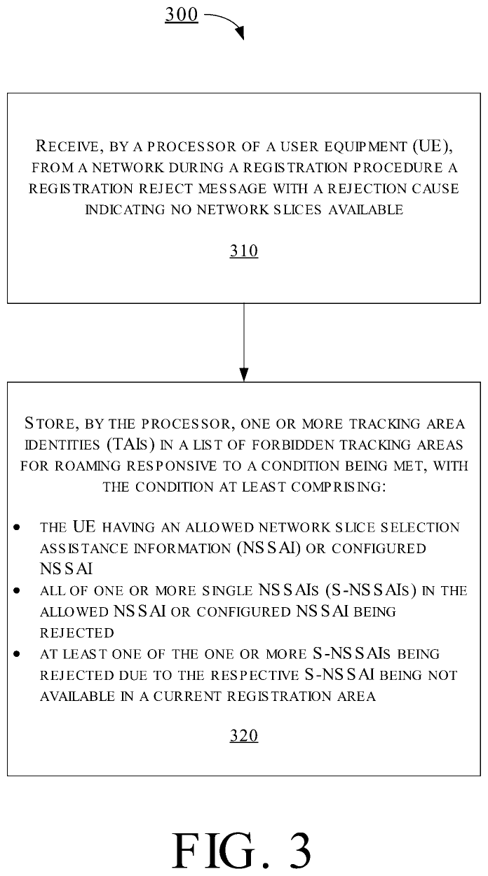

FIG. 3 illustrates an example process 300 in accordance with an implementation of the present disclosure. Process 300 may represent an aspect of implementing various proposed designs, concepts, schemes, systems and methods described above. More specifically, process 300 may represent an aspect of the proposed concepts and schemes pertaining to adding TAIs of a current registration area in a FTAI list after no slices available in wireless communications in accordance with the present disclosure. Process 300 may include one or more operations, actions, or functions as illustrated by one or more of blocks 310 and 320. Although illustrated as discrete blocks, various blocks of process 300 may be divided into additional blocks, combined into fewer blocks, or eliminated, depending on the desired implementation. Moreover, the blocks/sub-blocks of process 300 may be executed in the order shown in FIG. 3 or, alternatively, in a different order. Furthermore, one or more of the blocks/sub-blocks of process 300 may be executed repeatedly or iteratively. Process 300 may be implemented by or in apparatus 210 and apparatus 220 as well as any variations thereof. Solely for illustrative purposes and without limiting the scope, process 300 is described below in the context of apparatus 210 as a UE (e.g., UE 110) and apparatus 220 as a communication entity such as a network node or base station (e.g., network node 125) of a network (e.g., wireless network 120). Process 300 may begin at block 310.

At 310, process 300 may involve processor 212 of apparatus 210 as a UE (e.g., UE 110) receiving, via transceiver 216, from a network (e.g., network 120 via apparatus 220 as network node 125) during a registration procedure (e.g., an initial registration procedure or mobility registration procedure or network-initiated de-registration procedure) a registration reject message with a rejection cause (e.g., cause #62) indicating no network slices available. Process 300 may proceed from 310 to 320.

At 320, process 300 may involve processor 212 storing, in memory 214, one or more TAIs in a list of forbidden tracking areas for roaming responsive to a condition being met. The condition may at least include: (1) the UE having an allowed NSSAI or configured NSSAI; (2) all of one or more single NSSAIs (S-NSSAIs) in the allowed NSSAI or configured NSSAI being rejected; and (3) at least one of the one or more S-NSSAIs being rejected due to the respective S-NSSAI being not available in a current registration area.

In some implementations, the condition may further include: (4) the registration reject message being integrity protected; (5) the UE not operating in a SNPN access operation mode; (6) one or more forbidden TAIs for an IE of the list of forbidden tracking area for roaming being not included in the registration reject message; and (7) the registration reject message being received from at least one TAI in the current registration area. In such cases, in storing the one or more TAIS in the list of forbidden tracking areas for roaming, process 300 may involve processor 212 storing the one or more TAIs belonging to the current registration area in the list of forbidden tracking areas for roaming.

In some alternative implementations, the condition may further include: (4) the registration reject message being integrity protected; (5) the registration reject message being received from a TAI not in the current registration area. In such cases, in storing the one or more TAIs in the list of forbidden tracking areas for roaming, process 300 may involve processor 212 storing a current TAI in the list of forbidden tracking areas for roaming.

In some alternative implementations, the condition may further include: (4) the registration reject message being integrity protected; (5) the UE operating in a SNPN access operation mode; and (6) the registration reject message being received from at least one TAI in the current registration area. In such cases, in storing the one or more TAIs in the list of forbidden tracking areas for roaming, process 300 may involve processor 212 storing the one or more TAIs belonging to the current registration area in the list of forbidden tracking areas for roaming for a current SNPN.

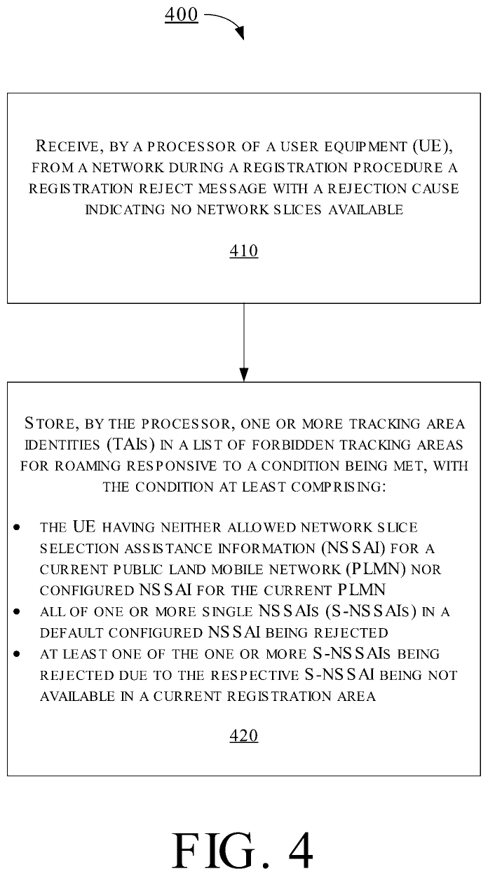

FIG. 4 illustrates an example process 400 in accordance with an implementation of the present disclosure. Process 400 may represent an aspect of implementing various proposed designs, concepts, schemes, systems and methods described above. More specifically, process 400 may represent an aspect of the proposed concepts and schemes pertaining to adding TAIs of a current registration area in a FTAI list after no slices available in wireless communications in accordance with the present disclosure. Process 400 may include one or more operations, actions, or functions as illustrated by one or more of blocks 410 and 420. Although illustrated as discrete blocks, various blocks of process 400 may be divided into additional blocks, combined into fewer blocks, or eliminated, depending on the desired implementation. Moreover, the blocks/sub-blocks of process 400 may be executed in the order shown in FIG. 4 or, alternatively, in a different order. Furthermore, one or more of the blocks/sub-blocks of process 400 may be executed repeatedly or iteratively. Process 400 may be implemented by or in apparatus 210 and apparatus 220 as well as any variations thereof. Solely for illustrative purposes and without limiting the scope, process 400 is described below in the context of apparatus 210 as a UE (e.g., UE 110) and apparatus 220 as a communication entity such as a network node or base station (e.g., network node 125) of a network (e.g., wireless network 120). Process 400 may begin at block 410.

At 410, process 400 may involve processor 212 of apparatus 210 as a UE (e.g., UE 110) receiving, via transceiver 216, from a network (e.g., network 120 via apparatus 220 as network node 125) during a registration procedure (e.g., an initial registration procedure or mobility registration procedure or network-initiated de-registration procedure) a registration reject message with a rejection cause (e.g., cause #62) indicating no network slices available. Process 400 may proceed from 410 to 420.

At 420, process 400 may involve processor 212 storing, in memory 214, one or more TAIs in a list of forbidden tracking areas for roaming responsive to a condition being met. The condition may at least include: (1) the UE having neither allowed NSSAI for a current public land mobile network (PLMN) nor configured NSSAI for the current PLMN; (2) all of one or more S-NSSAIs in a default configured NSSAI being rejected; and (3) at least one of the one or more S-NSSAIs being rejected due to the respective S-NSSAI being not available in a current registration area.

In some implementations, the condition may further include: (4) the registration reject message being integrity protected; (5) the UE not operating in a SNPN access operation mode; and (6) the registration reject message being received from at least one TAI in the current registration area. In such cases, in storing the one or more TAIs in the list of forbidden tracking areas for roaming, process 400 may involve processor 212 storing the one or more TAIs belonging to the current registration area in the list of forbidden tracking areas for roaming.

In some alternative implementations, the condition may further include: (4) the registration reject message being received from a TAI not in the current registration area. In such cases, in storing the one or more TAIs in the list of forbidden tracking areas for roaming, process 400 may involve processor 212 storing a current TAI in the list of forbidden tracking areas for roaming.

In some alternative implementations, the condition may further include: (4) the registration reject message being integrity protected; (5) the UE operating in a SNPN access operation mode; and (6) the registration reject message being received from at least one TAI in the current registration area. In such cases, in storing the one or more TAIs in the list of forbidden tracking areas for roaming, process 400 may involve processor 212 storing the one or more TAIs belonging to the current registration area in the list of forbidden tracking areas for roaming.

FIG. 5 illustrates an example process 500 in accordance with an implementation of the present disclosure. Process 500 may represent an aspect of implementing various proposed designs, concepts, schemes, systems and methods described above. More specifically, process 500 may represent an aspect of the proposed concepts and schemes pertaining to adding TAIs of a current registration area in a FTAI list after no slices available in wireless communications in accordance with the present disclosure. Process 500 may include one or more operations, actions, or functions as illustrated by one or more of blocks 510 and 520. Although illustrated as discrete blocks, various blocks of process 500 may be divided into additional blocks, combined into fewer blocks, or eliminated, depending on the desired implementation. Moreover, the blocks/sub-blocks of process 500 may be executed in the order shown in FIG. 5 or, alternatively, in a different order. Furthermore, one or more of the blocks/sub-blocks of process 500 may be executed repeatedly or iteratively. Process 500 may be implemented by or in apparatus 210 and apparatus 220 as well as any variations thereof. Solely for illustrative purposes and without limiting the scope, process 500 is described below in the context of apparatus 210 as a UE (e.g., UE 110) and apparatus 220 as a communication entity such as a network node or base station (e.g., network node 125) of a network (e.g., wireless network 120). Process 500 may begin at block 510.

At 510, process 500 may involve processor 212 of apparatus 210 as a UE (e.g., UE 110) receiving, via transceiver 216, from a network (e.g., network 120 via apparatus 220 as network node 125) during a network-initiated deregistration procedure a deregistration request message with a rejection cause (e.g., cause #62) indicating no network slices available. Process 500 may proceed from 510 to 520.

At 520, process 500 may involve processor 212 storing, in memory 214, one or more TAIs in a list of forbidden tracking areas for roaming responsive to a condition being met. The condition may at least include: (1) the UE having neither allowed NSSAI for a current public land mobile network (PLMN) or SNPN nor configured NSSAI for the current PLMN or SNPN; (2) all of one or more S-NSSAIs in a default configured NSSAI being rejected; and (3) at least one of the one or more S-NSSAIs being rejected due to the respective S-NSSAI being not available in a current registration area.

In some implementations, the condition may further include: (4) the UE not operating in a SNPN access operation mode; and (5) one or more forbidden TAIs for an IE of the list of forbidden tracking area for roaming being not included in a deregistration request message. In such cases, in storing the one or more TAIs in the list of forbidden tracking areas for roaming, process 500 may involve processor 212 storing the one or more TAIs belonging to the current registration area in the list of forbidden tracking areas for roaming. Moreover, process 500 may involve processor 212 performing additional operations. For instance, process 500 may involve processor 212 memorizing, in memory 214, that the one or more TAIs belonging to the current registration area were stored in the list of forbidden tracking areas for roaming for the respective S-NSSAI that is rejected due to the respective S-NSSAI being not available in a current registration area. Moreover, process 500 may involve processor 212 searching, via transceiver 216, for a suitable cell in another tracking area not belonging to the current registration area.

In some alternative implementations, the condition may further include: (4) the UE operating in a SNPN access operation mode. In such cases, in storing the one or more TAIs in the list of forbidden tracking areas for roaming, process 500 may involve processor 212 storing the one or more TAIs belonging to the current registration area in the list of forbidden tracking areas for roaming.

Moreover, process 500 may involve processor 212 performing additional operations. For instance, process 500 may involve processor 212 memorizing, in memory 214, that the one or more TAIs belonging to the current registration area were stored in the list of forbidden tracking areas for roaming for the respective S-NSSAI that is rejected due to the respective S-NSSAI being not available in a current registration area for the current registration area. Moreover, process 500 may involve processor 212 searching, via transceiver 216, for a suitable cell in another tracking area not belonging to the current registration area.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of a user equipment (UE), from a network during a registration procedure a registration reject message with a rejection cause indicating no network slices available; and
storing, by the processor, one or more tracking area identities (TAIs) in a list of forbidden tracking areas for roaming responsive to a condition being met,
wherein the condition at least comprises:
the UE having an allowed network slice selection assistance information (NSSAI) or configured NSSAI;
all of one or more single NSSAIs (S-NSSAIs) in the allowed NSSAI or configured NSSAI being rejected; and
at least one of the one or more S-NSSAIs being rejected due to the respective S-NSSAI being not available in a current registration area.

2. The method of claim 1, wherein the condition further comprises:
the registration reject message being integrity protected;
the UE not operating in a standalone non-public network (SNPN) access operation mode;
one or more forbidden TAIs for an information element (IE) of the list of forbidden tracking area for roaming being not included in the registration reject message; and
the registration reject message being received from at least one TAI in the current registration area,
wherein the storing of the one or more TAIs in the list of forbidden tracking areas for roaming comprises storing the one or more TAIs belonging to the current registration area in the list of forbidden tracking areas for roaming.

3. The method of claim 1, wherein the condition further comprises:
the registration reject message being received from a TAI not in the current registration area,
wherein the storing of the one or more TAIs in the list of forbidden tracking areas for roaming comprises storing a current TAI in the list of forbidden tracking areas for roaming.

4. The method of claim 1, wherein the condition further comprises:
the registration reject message being integrity protected;
the UE operating in a standalone non-public network (SNPN) access operation mode; and
the registration reject message being received from at least one TAI in the current registration area,
wherein the storing of the one or more TAIs in the list of forbidden tracking areas for roaming comprises storing the one or more TAIs belonging to the current registration area in the list of forbidden tracking areas for roaming for a current SNPN.

5. A method, comprising:
receiving, by a processor of a user equipment (UE), from a network during a registration procedure a registration reject message with a rejection cause indicating no network slices available; and
storing, by the processor, one or more tracking area identities (TAIs) in a list of forbidden tracking areas for roaming responsive to a condition being met,
wherein the condition at least comprises:
the UE having neither allowed network slice selection assistance information (NSSAI) for a current public land mobile network (PLMN) nor configured NSSAI for the current PLMN;
all of one or more single NSSAIs (S-NSSAIs) in a default configured NSSAI being rejected; and
at least one of the one or more S-NSSAIs being rejected due to the respective S-NSSAI being not available in a current registration area.

6. The method of claim 5, wherein the condition further comprises:
the registration reject message being integrity protected;
the UE not operating in a standalone non-public network (SNPN) access operation mode; and
the registration reject message being received from at least one TAI in the current registration area,
wherein the storing of the one or more TAIs in the list of forbidden tracking areas for roaming comprises storing the one or more TAIs belonging to the current registration area in the list of forbidden tracking areas for roaming.

7. The method of claim 5, wherein the condition further comprises:
the registration reject message being received from a TAI not in the current registration area,
wherein the storing of the one or more TAIs in the list of forbidden tracking areas for roaming comprises storing a current TAI in the list of forbidden tracking areas for roaming.

8. The method of claim 5, wherein the condition further comprises:
the registration reject message being integrity protected;
the UE operating in a standalone non-public network (SNPN) access operation mode; and
the registration reject message being received from at least one TAI in the current registration area,
wherein the storing of the one or more TAIs in the list of forbidden tracking areas for roaming comprises storing the one or more TAIs belonging to the current registration area in the list of forbidden tracking areas for roaming.

9. A method, comprising:
receiving, by a processor of a user equipment (UE), from a network during a network-initiated deregistration procedure a deregistration request message with a rejection cause indicating no network slices available; and
storing, by the processor, one or more tracking area identities (TAIs) in a list of forbidden tracking areas for roaming responsive to a condition being met,
wherein the condition at least comprises:
the UE having neither allowed network slice selection assistance information (NSSAI) for a current public land mobile network (PLMN) or standalone non-public network (SNPN) nor configured NSSAI for the current PLMN or SNPN;
all of one or more single NSSAIs (S-NSSAIs) in a default configured NSSAI being rejected; and
at least one of the one or more S-NSSAIs being rejected due to the respective S-NSSAI being not available in a current registration area.

10. The method of claim 9, wherein the condition further comprises:
the UE not operating in a SNPN access operation mode; and
one or more forbidden TAIs for an information element (IE) of the list of forbidden tracking area for roaming being not included in a deregistration request message,
wherein the storing of the one or more TAIs in the list of forbidden tracking areas for roaming comprises storing the one or more TAIs belonging to the current registration area in the list of forbidden tracking areas for roaming.

11. The method of claim 10, further comprising:
memorizing, by the processor, that the one or more TAIs belonging to the current registration area were stored in the list of forbidden tracking areas for roaming for the respective S-NSSAI that is rejected due to the respective S-NSSAI being not available in a current registration area; and
searching, by the processor, for a suitable cell in another tracking area not belonging to the current registration area.

12. The method of claim 9, wherein the condition further comprises:
the UE operating in a SNPN access operation mode,
wherein the storing of the one or more TAIs in the list of forbidden tracking areas for roaming comprises storing the one or more TAIs belonging to the current registration area in the list of forbidden tracking areas for roaming.

13. The method of claim 12, further comprising:
memorizing, by the processor, that the one or more TAIs belonging to the current registration area were stored in the list of forbidden tracking areas for roaming for the respective S-NSSAI that is rejected due to the respective S-NSSAI being not available in a current registration area for the current registration area; and
searching, by the processor, for a suitable cell in another tracking area not belonging to the current registration area.
